(19) United States
(12) Patent Application Publication
(10) Pub. No.: US 2016/0335585 A1
(43) Pub. Date: Nov. 17, 2016

(54) SERVICE PROVIDING SERVER AND METHOD FOR PROVIDING PRODUCT DELIVERY SERVICE THEREOF

(71) Applicant: Kwan S Suh, Ambler, PA (US)

(72) Inventor: Kwan S Suh, Ambler, PA (US)

(21) Appl. No.: 14/817,480

(22) Filed: Aug. 4, 2015

(30) Foreign Application Priority Data
May 15, 2015 (KR) 10-2015-0068022

(51) Int. Cl. G06Q 10/08; G06Q 20/14; G06Q 30/06

(52) U.S. Cl. CPC G06Q 10/083; G06Q 30/0635; G06Q 20/14

(57) ABSTRACT

A service providing server, which provides a product delivery service for delivering a product between terminals located at places different from one another, includes a communication unit that communicates with a plurality of terminals. A user information management unit that manages product purchase information and product delivery information received from the plurality of terminals provides the product purchase information received from a buyer terminal to a deliverer terminal and provides the product delivery information received from the deliverer terminal to the buyer terminal. When a terminal corresponding to the product delivery is selected by one of the buyer terminal or the deliverer terminal, a device connection unit connects the terminals to each other for product delivery negotiation. A product delivery information management unit that manages product delivery negotiation information between the buyer terminal and the deliverer terminal between which the product delivery negotiation is completed.

The current application claims a priority to the Korean Patent Application serial number 10-2015-0068022 filed on May 15, 2015, the disclosure of which is incorporated herein by reference in its entirety.

### FIELD OF THE INVENTION

The present invention relates generally to a product delivery system, and more particularly, to a server which provides product delivery service via airplane between individual users located in different areas and countries, and a method for providing product delivery service thereof.

### BACKGROUND OF THE INVENTION

Around the world, producers manufacture and deliver products to various customers through transactions. However, the producers are not always located in the same area as that of the customers or have difficulty expanding their stores over the world due to various reasons. Accordingly, same products are sold at different prices in different areas and countries. However, today's customers want to buy various products at the lowest expense, but are limited to buy products through distribution channels in their own area or country due to spatial constraints. In addition, customers can buy products directly through foreign distribution channels, but in such cases, huge transport costs may be required. In addition, customers generally purchase small amounts of products, but in case of small amounts of products, there are many cases where the transport cost is higher than the product purchase cost, and becomes a burden to the customers.

An object of the present invention is to provide a service providing server which allows a customer to buy a product at an optimal price without spatial constraints, and a method for providing product delivery service thereof. Another object of the present invention is to provide a service providing server capable of reducing the transport cost that accompanies product purchase, and a method for providing product delivery service thereof. Still another object of the present invention is to provide a service providing server which delivers a product between individual application users located in different areas by providing an application which provides product delivery service, and a method for providing product delivery service thereof.

### SUMMARY OF THE INVENTION

A service providing server according to the present invention includes: a communication unit that communicates with a plurality of terminals; a user information management unit that manages product purchase information and product delivery information received from the plurality of terminals, provides the product purchase information received from a buyer terminal among the plurality of terminals to a deliverer terminal, and provides the product delivery information received from the deliverer terminal to the buyer terminal; a device connection unit that, when a terminal corresponding to product delivery is selected by one of the buyer terminal or the deliverer terminal, connects the terminals to each other for product delivery negotiation with the selected terminal, and receives confirmation whether the product delivery negotiation between the buyer terminal, the deliverer terminal is completed, to decide on the meeting location and time in case of a flight delay, cancel request or a delivery (by the request/buyer or delivery), and report a failed delivery. a product delivery information management unit that manages product delivery negotiation information between the buyer terminal and the deliverer terminal between which the product delivery negotiation is completed, to be shared between the buyer terminal and the deliverer terminal; and a memory that stores the product purchase information, the product delivery information, and the product delivery negotiation information.

In this embodiment, the user information management unit receives user information including at least one of first and last name, address, e-mail address, nationality, country of residence, gender, phone number, ID, and password, input from the plurality of terminals.

In this embodiment, the product purchase information includes at least one of product place of origin, delivery destination, name of product purchased, product category, number of products, product purchase price, product purchase link, image related to product purchased, detailed product information, meeting place/airport, and product delivery fee.

In this embodiment, the product delivery information includes at least one of connection information between deliverer terminal and buyer terminal, destination, and travel schedule.

In this embodiment, the product delivery negotiation information includes information about the deliverer terminal and the buyer terminal between which the negotiation is completed, destination of the deliverer terminal, and travel schedule.

In this embodiment, the device connection unit connects the buyer terminal and the deliverer terminal to each other when the deliverer terminal is selected by the buyer terminal or the buyer terminal is selected by the deliverer terminal.

In this embodiment, the device connection unit activates a chat box capable of transmitting texts, images, and videos for connection between the buyer terminal and the deliverer terminal.

In this embodiment, the device connection unit confirms that the product delivery negotiation is completed when the device connection unit receives information agreeing to the product delivery from both the buyer terminal and the deliverer terminal.

A method for providing product delivery service according to the present invention includes: receiving user information input from a plurality of terminals; receiving product purchase information for product purchase input from a buyer terminal that wants to buy a product, among the plurality of terminals; receiving product delivery information for product delivery input from the deliverer terminal that wants to deliver a product, among the plurality of terminals; providing the product purchase information to the deliverer terminal, and providing the product delivery information to the buyer terminal; selecting a terminal for product purchase or product delivery from one of the buyer terminal or the deliverer terminal; sharing information related to the product delivery negotiation with the buyer terminal and the deliverer terminal when the product delivery negotiation with the selected terminal is completed; and paying the costs to the deliverer terminal for product delivery of the buyer terminal upon the approval of the buyer terminal through the product delivery negotiation.

In this embodiment, the method further includes receiving settlement related information for the product purchase and the product delivery input from the plurality of terminals.

In this embodiment, wherein the user information includes at least one of first and last name, country of residence, gender, address, e-mail address, nationality, phone number, ID, and password.

In this embodiment, the product purchase information includes at least one of product place of origin, delivery destination, name of product purchased, product category, number of products, product purchase price, product purchase link, image related to product purchased, detailed product information, meeting place/airport, and product delivery fee.

In this embodiment, the product delivery information includes at least one of connection information between deliverer terminal and buyer terminal, destination, and travel schedule.

In this embodiment, the product delivery negotiation information includes information about the deliverer terminal and the buyer terminal between which the negotiation is completed, destination of the deliverer terminal, and travel schedule.

In this embodiment, the method further includes connecting the buyer terminal and the deliverer terminal to each other after the selection of the terminal for product purchase or product delivery.

In this embodiment, the connecting includes activating a chat box capable of transmitting texts, images, and videos between the buyer terminal and the deliverer terminal.

In this embodiment, the sharing of information between the buyer terminal and the deliverer terminal includes confirming that the product delivery negotiation is completed when receiving information agreeing to the product delivery from both of the buyer terminal and the deliverer terminal.

In this embodiment, the method includes: receiving a product price adjustment request from one of the buyer terminal or the deliverer terminal after the sharing of information related to the product delivery negotiation with the buyer terminal and the deliverer terminal; and resetting the product price when receiving information agreeing to the product price adjusted by the deliverer terminal or the buyer terminal corresponding to the receiving of the product price request, and completing the product delivery negotiation when receiving information disagreeing to the adjusted product price.

In this embodiment, the method further includes: receiving a product delivery cancelation request from one of the buyer terminal or the deliverer terminal after the sharing of information related to the product delivery negotiation with the buyer terminal and the deliverer terminal; and canceling the product delivery when the predetermined product delivery cancelable period has not elapsed through determination of whether the predetermined product delivery cancelable period has elapsed according to the product delivery cancelation request, and reporting a product delivery cancel failure when the product delivery cancelable period has elapsed.

In this embodiment, the method further includes: receiving a product delivery failure request from one of the buyer terminal or the deliverer terminal after the sharing of information related to the product delivery negotiation with the buyer terminal and the deliverer terminal; and refunding a part or all of the product delivery fee and all of the product purchase price to the buyer terminal, upon receiving information agreeing to the product delivery failure from the deliverer terminal or the buyer terminal corresponding to the product delivery failure.

### BRIEF DESCRIPTION OF THE DRAWINGS

FIG. 1 is an exemplary diagram illustrating a product delivery service providing system according to the present invention;

FIG. 2 is an exemplary diagram illustrating a procedure of receiving input information for providing product delivery service according to the present invention;

FIG. 3 is an exemplary diagram illustrating selection and connection operations between terminals for product delivery service according to the present invention;

FIG. 4a and FIG. 4b are diagrams illustrating a negotiation operation between terminals for product delivery according to an embodiment of the present invention;

FIG. 5 is an exemplary diagram illustrating a product price adjustment operation according to the present invention;

FIG. 6 is an exemplary diagram illustrating a product delivery cancelation operation according to the present invention;

FIG. 7 is an exemplary diagram illustrating a product delivery failure operation according to the present invention; and

FIG. 8 is an exemplary diagram illustrating a service providing server according to the present invention.

### DETAIL DESCRIPTIONS OF THE INVENTION

All illustrations of the drawings are for the purpose of describing selected versions of the present invention and are not intended to limit the scope of the present invention.

Hereinafter, preferred embodiments of the present invention will be described in detail with reference to the accompanying drawings. In the following description, it should be noted that only parts necessary to understand an operation according to the present invention will be described, and the other parts will be omitted so as not to blur the gist of the present invention.

The present invention provides a service providing server which allows customers to buy a product at an optimal price without spatial constraints, and a method for providing product delivery service thereof. For this purpose, the service providing server according to the present invention can support the exchange of information related to the purchase, delivery, and delivery fee payment of a product between the terminal (deliverer terminal) of a person (hereinafter, referred to as ‘deliverer’) who delivers a product through travel between areas or countries, and the terminal (buyer terminal) of a person (hereinafter, referred to as ‘buyer’) who wants to buy the product.

The service provided between terminals through the service providing server in the present invention is a product delivery service of receiving a product at the departure place of the deliverer, and then delivering the product to a buyer who wants to receive the product at the destination, as the deliverer travels through various travel means such as airplane, ship, bus, train, and automobile for tour, study, business, or the like.

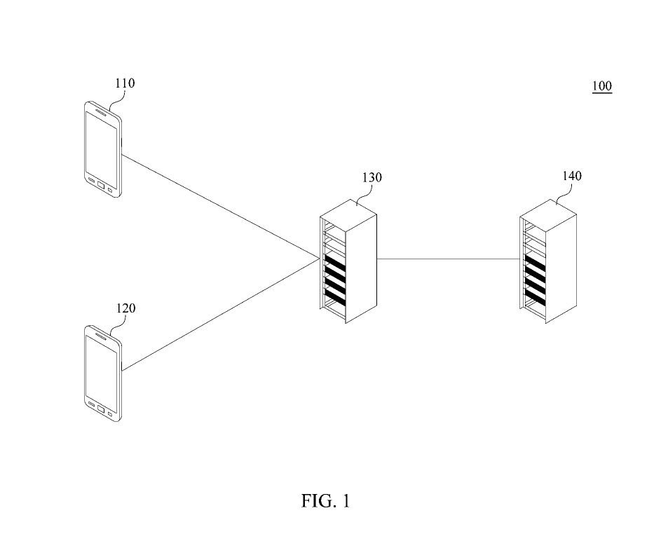

FIG. 1 is an exemplary diagram illustrating a product delivery service providing system according to the present invention. Referring to FIG. 1, a product delivery service providing system 100 includes a first terminal 110, a second terminal 120, and a service providing sever 130. The product delivery service providing system 100 may further include a financial sever 140.

The first terminal 110 and the second terminal 120 are connected to the service providing server 130 through a communication network. The first terminal 110 and the second terminal 120 include all terminals which can access the service providing server 130, such as tablets, laptops, and personal computers (PCs), as well as the illustrated smartphones.

In this case, the first terminal 110 and the second terminal 120 may be a buyer terminal requesting product purchase according to the user's need, or a deliverer terminal delivering a product upon the user's request. In the following description, it is assumed that the first terminal 110 is the buyer terminal, and the second terminal 120 is the deliverer terminal for the convenience of description.

A product delivery application supported by the service providing server 130 may be stored and operated within the first terminal 110 and the second terminal 120, and the product delivery service can be provided through the operation of the application. In addition, the first terminal 110 and the second terminal 120 may provide a product delivery service which provides service to a user through a web page or a web site provided through the internet.

The service providing server 130 can collect information related to the product delivery service from the terminals 110 and 120, and provide the collected information to the requested terminals 110 and 120. The service providing server 130 receives product purchase information input from the first terminal 110, and receives product delivery information input from the second terminal 120. The service providing server 130 can provide the product purchase information of the buyer terminals, including the first terminal 110, to the second terminal 120, and can provide the product delivery information of the deliverer terminals, including the second terminal 120, to the first terminal 110.

Accordingly, the service providing server 130 can receive information input from the first terminal 110 or the second terminal 120 regarding the selection of a terminal to deliver the product or the selection of a terminal to request product delivery. Then, the service providing server 130 enables a negotiation for product delivery through connection (for example, a form such as a chat box) between the terminals.

For example, when the product delivery negotiation is completed between the first terminal 110 and the second terminal 120, the service providing server 130 can manage the product delivery negotiation information between the first terminal 110 and the second terminal 120, and provide the managed information to the first terminal 110 or the second terminal 120.

The financial server 140 manages financial information related to settlement (name, billing address, and credit card information) or payment of costs related to the purchase and delivery of the product (product purchase price and product delivery fee). Accordingly, the financial server 140 may include the function of a settlement server. In addition, the financial server 140 can manage user information, bank, account information, user authentication information, and the like, to provide financial services to the first terminal 110 and the second terminal 120. In addition, when separate settlement payment means (for example, virtual money (cyber money)) are provided in the service providing server 130, the financial server 140 can support the financial service for the use of virtual money. When money (currency) information differs according to area or country, the financial server 140 may perform the function of converting the costs by applying an exchange rate based on the reference money set in the terminal.

For example, the service providing server 130 receives product purchase information input from the first terminal 110. In addition, the service providing server 130 receives product delivery available information input from the second terminal 120. In this case, the product purchase information input from other terminals including the first terminal 110 may be provided to the second terminal 120, or the product delivery information input from other terminals including the second terminal 120 may be provided to the first terminal 110.

It is assumed that the first terminal 110 is a buyer terminal located in Korea, and the second terminal 120 is a deliverer terminal located in the U.S. Accordingly, the first terminal 110 may want to buy and receive a television (TV) marketed in the U.S. through the second terminal 120. In this case, when the service providing server 130 receives completion information of the product delivery negotiation related to the television purchase from both of the first terminal 110 and the second terminal 120, the product delivery negotiation information can be shared between the terminals. In addition, the service providing server 130 allows a product delivery fee based on product delivery completion, that is, a negotiation-completed product delivery fee, to be provided from the first terminal 110 to the second terminal 120, and can claim a part of the product delivery fee in the form of a fee for providing connection between the terminals through the first terminal 110 or the second terminal 120.

Accordingly, the service providing server 130 proposed in the present invention provides a product delivery service related to product purchase or delivery between persons moving between areas or countries. Therefore, the buyer can buy the product at the optimal price without spatial constraints, and can receive the delivered product at the optimal cost.

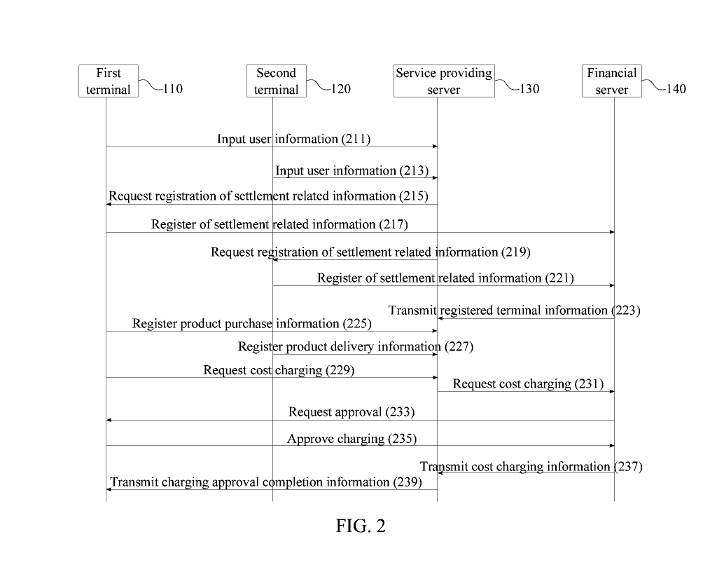

FIG. 2 is an exemplary diagram illustrating a procedure of receiving input information for providing the product delivery service according to the present invention. Referring to FIG. 2, the first terminal 110 registers user information in the service providing server 130 (Step 211). The second terminal 120 registers user information in the service providing server 130 (Step 213).

In this case, the user information registered in the service providing server 130 by the first terminal 110 and the second terminal 120 may include name (for example, first name and last name), gender, address (residential information), e-mail address, nationality, phone number, ID (or user name or nickname (another name)), and password. In addition, a part of the user information may be selectively requested, and additional information may be required for register as necessary.

In this case, the service providing server 130 manages the user information input from the first terminal 110 and the second terminal 120.

The service providing server 130 requests the first terminal 110 to register settlement related information for paying or receiving the product purchase cost or the product delivery fee in the financial server 140 (Step 215). In this case, the settlement related information is information which enables paying or receiving the cost, and may include credit card information or account information (including virtual account (for example, account temporarily created to pay the product delivery fee)).

The first terminal 110 registers the settlement related information in the financial server 140 according to the request to register the settlement related information (Step 217).

The service providing server 130 requests the second terminal 120 to register the settlement related information for paying or receiving the product purchase cost or the product delivery fee in the financial server 140 (Step 219).

The second terminal 120 registers the settlement related information in the financial server 140 according to the request to register the settlement related information (Step 221).

The financial server 140 provides the information of the terminal in which the settlement related information is registered to the service providing server 130.

The first terminal 110 registers, as the buyer terminal, the product purchase information about the product it wants to buy in the service providing server 130 (Step 225). The product purchase information includes product destination (for example, current country and residential area (including adjacent airport, port, terminal, platform, and the like)), name of product purchased, number of products, product price (or product purchase price), product purchase link, image related to product purchased (for example, product image), detailed product information (for example, including model name, color, size, and the like), and product delivery fee. As described above, the service providing server 130 can provide a list of product purchase information (buyer information, product item, and the like) requested from the travel-planned country or area of the deliverer terminal through the registration of the product purchase information.

The second terminal 120 registers, as the deliverer terminal, the product delivery information for delivery of the product in the service providing server 130 (Step 227). The product delivery information includes departure place information (country, departure place address, and the like) according to the travel of the deliverer, destination information (country and destination (for example, airport, port, terminal, platform, and the like)), and travel schedule (departure date, departure time, arrival date, period of stay, and the like). As described above, the service providing server 130 can provide a list of information of the deliverer visiting the corresponding country or area to the terminals requesting the delivery of the products through the registration of the product delivery information.

For example, the first terminal 110 and the second terminal 120 can input the product purchase information or the product delivery information in a manner of dropdown, text input, or the like provided from the service providing server 130.

The first terminal 110 requests the service providing server 130 to charge the costs (Step 229).

The service providing server 130 requests the financial server 140 to charge the costs of the first terminal 110 (Step 231). In this case, the cost charging means charging of virtual money managed in the service providing server 130.

The financial server 140 requests the first terminal 110 for approval according to the cost charging (Step 233).

The first terminal 110 transmits information about the charging approval according to the cost charging to the financial server 140 (Step 235).

The financial server 140 transmits cost charging information according to completion of the cost charging to the service providing server 130 (Step 237).

When the completion of the cost charging is confirmed through the financial server 140, the service providing server 130 transmits charging approval completion information to the first terminal 110 (Step 239). Accordingly, the first terminal 110 can check the costs (for example, virtual money) charged in the service providing server 130, and can pay the product purchase cost or the product delivery fee through the charged costs.

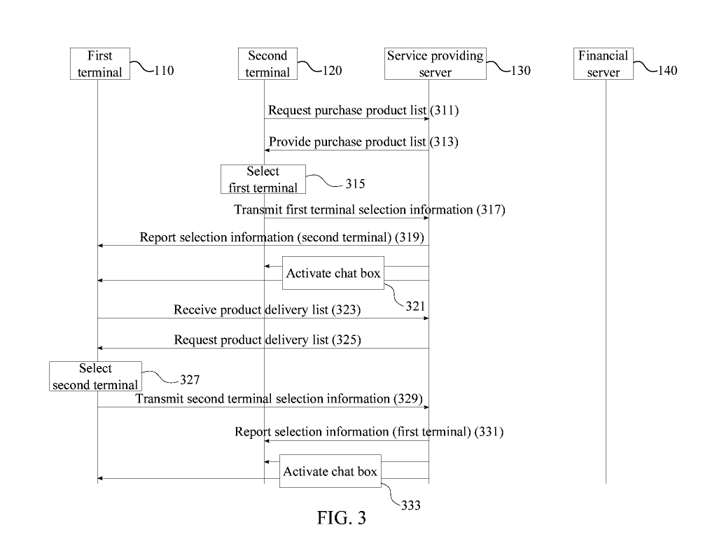

FIG. 3 is an exemplary diagram illustrating selection and connection operations between the terminals for the product delivery service according to the present invention. Referring to FIG. 3, the second terminal 120 requests the service providing server 130 for a product purchase list to search the product to deliver (Step 311).

The service providing server 130 provides the product purchase list to the second terminal 120 (Step 313). The product purchase list is managed in the service providing server 130 according to the product purchase information input from the terminals including the first terminal 110, and includes the product purchase information input from the terminals.

The second terminal 120 receives information selecting the first terminal 110 input from the user to deliver the product (Step 315).

The second terminal 120 transmits the selection information of the first terminal 110 to the service providing server 130 (Step 317).

The service providing server 130 reports the selection information about the first terminal 110 from the second terminal 120 to the first terminal 110 to deliver the product (Step 319).

The service providing server 130 can connect the first terminal 110 and the second terminal 120 to each other to agree on product delivery and can, for example, activate a chat box between the first terminal 110 and the second terminal 120 (Step 321).

In addition, the first terminal 110 requests the service providing server 130 for a deliverer visit list for selecting a user to deliver the product (Step 323).

The service providing server 130 provides the deliverer visit list to the first terminal 110 (Step 325). The deliverer visit list is managed in the service providing server 130 according to the product delivery information input from the terminals including the second terminal 120, and includes information about travel country (or travel area) of the deliverer. For example, the deliverer visit list may be arranged in a list of deliverer names (deliverer ID and the like) moving to the country or area where the user of the first terminal 110 is located.

The first terminal 110 receives information selecting the second terminal 120 input from the user to receive the delivered product (Step 327). In this case, the first terminal 110 can receive selection of a desired deliver's terminal, that is, the second terminal 120, from the user through the deliverer visit list.

The first terminal 110 transmits the selection information of the second terminal 120 to the service providing server 130 (Step 329).

The service providing server 130 reports the selection information about the second terminal 120 from the first terminal 110, to the second terminal 120 to request the product delivery (Step 331).

The service providing server 130 can connect the first terminal 110 and the second terminal 120 to each other to agree on product delivery and can, for example, activate a chat box between the first terminal 110 and the second terminal 120 (Step 333).

As described in Step 311 to Step 321, the chat box can be activated by the selection of the other terminal for the product delivery by the second terminal 120, and as described in Step 323 to Step 333, the chat box can be activated by the selection of the other terminal for the product delivery by the first terminal 110.

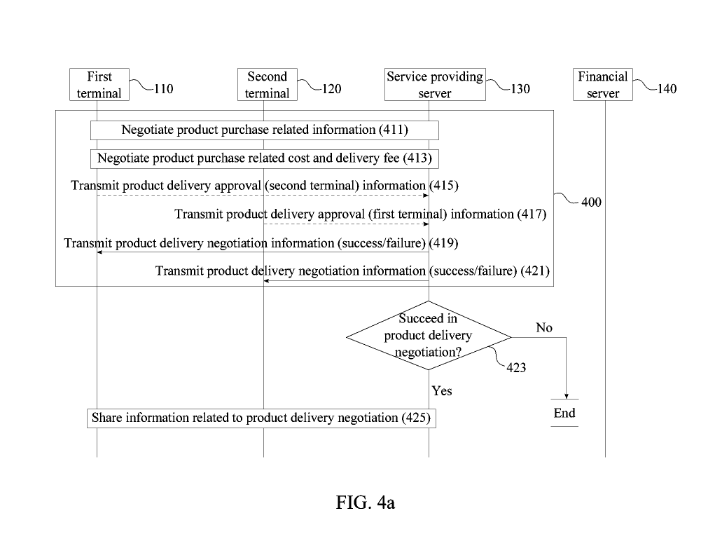

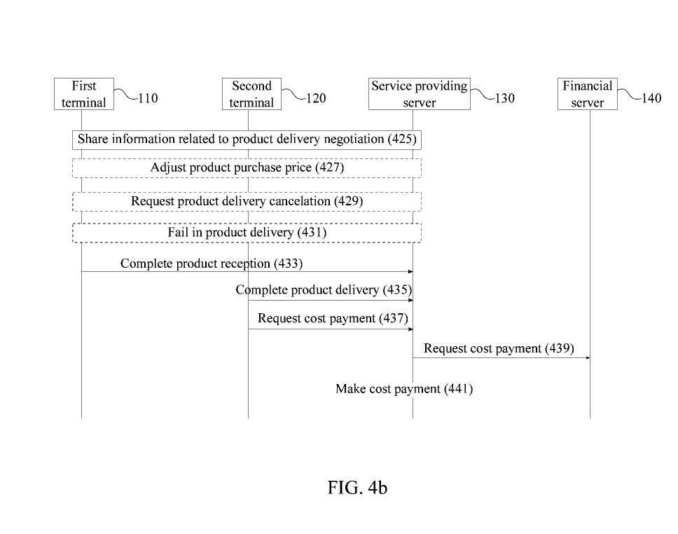

FIG. 4a and FIG. 4b are diagrams illustrating a negotiation operation between the terminals according to the product delivery according to the embodiment of the present invention.

Referring to FIG. 4a, a chat box 400 connected between the first terminal 110 and the second terminal 120 in the service providing server 130 is exemplarily illustrated. The following Step 411 to Step 421 can be performed through the chat box 400.

The first terminal 110 and the second terminal 120 negotiate information related to product purchase through the service providing server 130 (Step 411). For this purpose, the first terminal 110 and the second terminal 120 can transmit and receive data including texts, images, and videos to and from each other. Meanwhile, when the first terminal 110 directly performs product purchase, the first terminal 110 receives the departure place address provided by the second terminal 120, and the first terminal 110 may provide only the information related to the purchase completion to the second terminal 120.

When the negotiation of the information related to the product purchase is completed, the first terminal 110 and the second terminal 120 negotiate the purchase related cost (that is, product price) and delivery fee of the product (Step 413). The first terminal 110 requests to buy the product through the second terminal 120, and may negotiate the product price upon the request of the product purchase through the second terminal 120. If the first terminal 110 can directly buy the product, it is possible to directly buy the product, and the negotiation of the product price may not be necessary. In addition, when the product delivery fee is predetermined according to kind, size, volume, and the like of the product in the service providing server 130, the negotiation of the product delivery fee may not be necessary. As described above, when the negotiation of the product purchase cost and the product delivery fee is unnecessary, Step 413 may not be performed.

When the product delivery by the second terminal 120 is approved through Step 411 to Step 413, the first terminal 110 transmits product delivery approval information to the service providing server 130 (Step 415).

In addition, when the delivery of the product requested from the first terminal 110 is approved (when the purchase of the product is necessary, including the purchase approval of the product) through Step 411 to Step 413, the second terminal 120 transmits the product delivery approval information to the service providing server 130 (Step 417).

When the service providing server 130 receives the product delivery approval information from both of the first terminal 110 and the second terminal 120, the service providing server 130 determines the product delivery negotiation as success. When the service providing server 130 does not receive the product delivery approval information from at least one of the first terminal 110 and the second terminal 120, the service providing server 130 determines the product delivery negotiation as failure.

The service providing server 130 transmits the information about the success or failure of the product delivery negotiation to the first terminal 110 (Step 419). In addition, the service providing server 130 transmits the information about the success or failure of the product delivery negotiation to the second terminal 120 (Step 421).

As described above, the message or information transmitted between the first terminal 110 and the second terminal 120 through the chat box 400 passes through the service providing server 130, and may be stored in the service providing server 130 until the time of the product delivery completion or a predetermined time after the product delivery completion. In addition, once the chat box 400 is connected between the first terminal 110 and the second terminal 120 by the service providing sever 130, the chat box 400 is activated by a request of the first terminal 110, the second terminal 120, or the service providing server 130, to transmit messages or information.

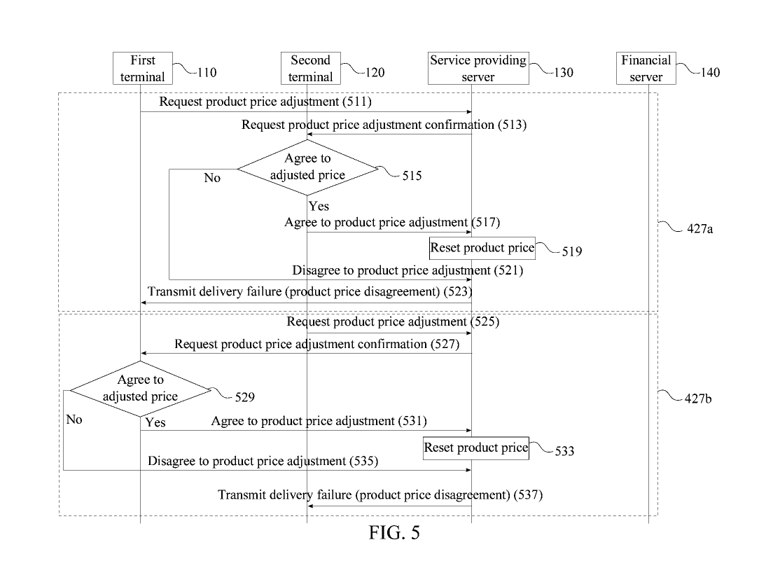

When the product delivery negotiation succeeds, the service providing server 130 proceeds to Step 425. However, when the product delivery negotiation fails, the service providing server 130 proceeds to Step 511 illustrated in FIG. 5 (Step 423).

The service providing server 130 shares the product delivery negotiation information with the first terminal 110 or the second terminal 120 (Step 425). The product delivery negotiation information includes information of the buyer terminal (the first terminal 110) and the deliverer terminal (the second terminal 120) between which the negotiation is completed, the product purchase information from the first terminal 110, and the product delivery information from the second terminal 120. Particularly, the product delivery negotiation information includes the destination of the user (deliverer) of the second terminal 110, travel schedule (destination arrival date), the agreed delivery fee, and the like, to allow the information for product reception to be confirmed in the first terminal 110. In this case, after the second terminal 120 starts delivering the product on the basis of the location information, the second terminal 120 can provide the location information based on the travel of the deliverer to the first terminal 110 through the service providing server 130. Accordingly, the first terminal 110, which is the buyer terminal, can check the approximate location of the product being delivered.

Referring to FIG. 4b, the first terminal 110 and the second terminal 120 may adjust the agreement-completed product price (Step 427). In this case, either the first terminal 110 or the second terminal 120 may request the product price, and an operation of adjusting the product price will be described below with reference to FIG. 5.

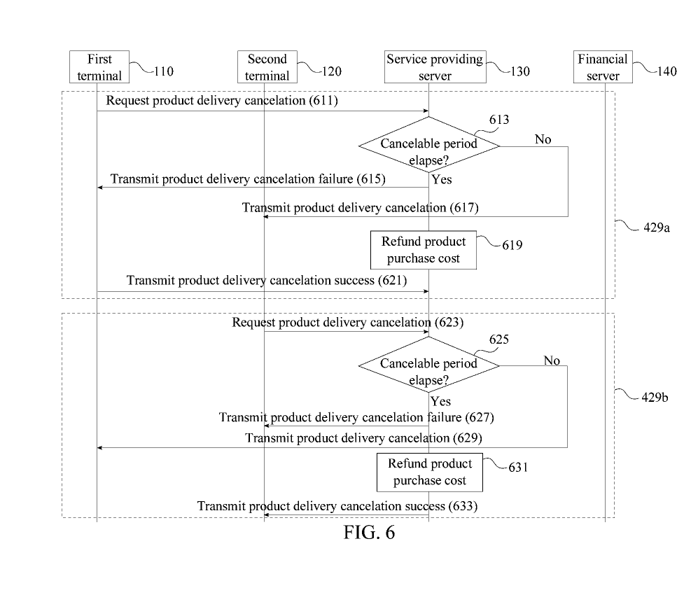

The first terminal 110 and the second terminal 120 may request cancelation of the agreement-completed product delivery (Step 429). In this case, either the first terminal 110 or the second terminal 120 may request the product delivery cancelation, and an operation according to the product delivery cancelation request will be described below with reference to FIG. 6.

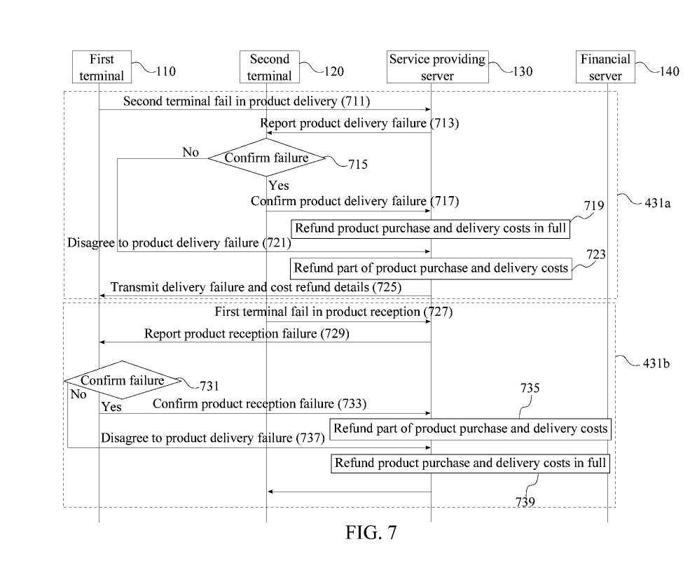

The first terminal 110 and the second terminal 120 may fail to deliver the product at the agreed place at the time of the product delivery (Step 431). An operation according to the failure of the product delivery in the first terminal 110 or the second terminal 120 will be described below with reference to FIG. 7.

As described above, the operations of Step 427 to Step 431 may or may not be performed according to the request or the situation of the first terminal 110 or the second terminal 120.

When the first terminal 110 receives the product through the second terminal 120, the first terminal 110 transmits information about the product reception completion to the service providing server 130 (Step 433).

When the second terminal 120 completes the delivery of the product to the first terminal 110, the second terminal 120 transmits information about the product delivery completion to the service providing server 130 (Step 435).

The service providing server 130 can confirm that the product delivery is normally completed from both of the first terminal 110 and the second terminal 120 through Step 433 and Step 435.

Accordingly, the second terminal 120 may transmit a payment request to the service providing server 130 (Step 437). Meanwhile, when the service providing server 130 confirms the product delivery is normally completed in order to receive the payment request from the second terminal 120, the service providing server 130 may provide information about the product delivery completion to the second terminal 120.

The service providing server 130 requests the financial server 140 in order to receive actual money converted from the virtual money paid to the second terminal 120 through the agreement with the first terminal 110 (Step 439).

The financial server 140 pays the product purchase cost or the actual money to the second terminal 120 on the basis of the financial information (for example, account number, credit card, and the like) of the second terminal 120.

Although not illustrated in detail in FIG. 4a and FIG. 4b, when the first terminal 110 receives the product, the first terminal 110 may transmit information representing the product delivery completion to the service providing server 130, and when the product delivery or the cost payment is completed, the second terminal 120 may transmit information representing the product delivery completion to the service providing server 130.

As described above, when the service providing server 130 receives the information representing the product delivery completion from the first terminal 110 and the second terminal 120, the service providing server 130 may delete the information related to the product delivery negotiation.

FIG. 5 is an exemplary diagram illustrating an operation according to the product price adjustment according to the present invention. Referring to FIG. 5, a detailed operation of Step 427 of adjusting the product price illustrated in FIG. 4b will be exemplarily described. In this case, reference numeral 427a denotes an operation according to a request for product price adjustment in the first terminal 110, and reference numeral 427b denotes an operation according to the request for product price adjustment in the second terminal 120.

The first terminal 110 requests the service providing server 130 to adjust the product price (Step 511). In this case, the first terminal 110 receives information for adjustment of the negotiation-completed product price input from a user. The first terminal 110 receives an adjustment-desired produce price input from the user, and transmits the information including the information about the adjusted and input product price to the service providing server 130.

The service providing server 130 requests the second terminal 120 to confirm the product price adjustment to the product price requested from the first terminal 110, according to the product price adjustment request of the first terminal 110 (Step 513).

The second terminal 120 determines whether information about agreement or disagreement to the adjusted price is input from the user, that is, the deliverer (Step 515). In this case, when the second terminal 120 agrees to the adjustment of the product price, it proceeds to Step 517, and when the second terminal 120 does not agree to the adjustment of the product price, it proceeds to Step 521.

The second terminal 120 transmits the information of agreeing to the adjustment of the product price to the service providing server 130 (Step 517).

Accordingly, the service providing server 130 resets the product price set at the time of the product delivery negotiation between the first terminal 110 and the second terminal 120 (Step 519). The service providing server 130 may transmit information representing that the adjustment of the product price has succeeded to the first terminal 110.

The second terminal 120 transmits information disagreeing to, that is, not agreeing to the adjustment of the product price to the service providing server 130 (Step 521). In this case, when the service providing server 130 receives the information disagreeing to the product price adjustment from the second terminal 120, the service providing server 130 determines that the product delivery negotiation fails.

The service providing server 130 transmits the delivery failure according to the disagreement to the product price from the second terminal 120 to the first terminal 110 (Step 523).

On the contrary, the second terminal 120 requests the service providing server 130 to adjust the product price (Step 525). In this case, the second terminal 120 receives the information for the adjustment of the negotiation-completed product price input from the user. The second terminal 120 receives the adjustment-desired product price input from the user, and transmits the information including the information about the adjusted and input product price to the service providing server 130.

The service providing server 130 requests the first terminal 110 to confirm the product price adjustment to the product price requested from the second terminal 120, according to the product price adjustment request of the second terminal 120 (Step 527).

The first terminal 110 determines whether information about agreement or disagreement to the adjusted price is input from the user, that is, the buyer (Step 529). In this case, when the first terminal 110 agrees to the adjustment of the product price, it proceeds to Step 531, and when the first terminal 110 does not agree to the adjustment of the product price, it proceeds to Step 535.

The first terminal 110 transmits the information agreeing to the adjustment of the product price to the service providing server 130 (Step 531).

Accordingly, the service providing server 130 resets the product price set at the time of the product delivery negotiation between the first terminal 110 and the second terminal 120 (Step 533). The service providing server 130 may transmit information representing that the adjustment of the product price has succeeded to the second terminal 120.

The first terminal 110 transmits information disagreeing to, that is, not agreeing to the adjustment of the product price to the service providing server 130 (Step 535). In this case, when the service providing server 130 receives the information disagreeing to the product price adjustment from the first terminal 110, the service providing server 130 determines that the product delivery negotiation has failed.

The service providing server 130 transmits the delivery failure according to the disagreement to the product price from the first terminal 110, to the second terminal 120 (Step 537).

FIG. 6 is an exemplary diagram illustrating an operation based on product delivery cancelation according to the present invention. Referring to FIG. 6, a detailed operation of Step 429 of canceling the product delivery illustrated in FIG. 4b will be exemplarily described. In this case, reference numeral 429a denotes an operation according to a request of the cancelation of the product delivery in the first terminal 110, and reference numeral 429b denotes an operation according to the request of the cancelation of the product delivery in the second terminal 120.

The first terminal 110 requests the service providing server 130 to cancel the product delivery (Step 611). In this case, the first terminal 110 receives information for canceling the product delivery negotiation with the second terminal 120 input from the user.

When the service providing server 130 receives the product delivery cancelation request from the first terminal 110, the service providing server 130 determines whether the product delivery cancelable period has elapsed (Step 613). The product delivery cancelable period may be predetermined by the service providing server 130, and may be set on the basis of day or time. For example, when the product delivery cancelable period is set to 3 days, the service providing server 130 determines whether 3 days have elapsed from the time the product delivery negotiation was completed. Accordingly, when the product delivery cancelable period has elapsed, the service providing server 130 proceeds to Step 615, and when the product delivery cancelable period has not elapsed, it proceeds to Step 617.

The service providing server 130 transmits the product delivery cancelation failure to the first terminal 110 with the lapse of the product delivery cancelable period (Step 615). Accordingly, the first terminal 110 and the second terminal 120 maintain the product delivery agreement.

However, when the product delivery cancelable period has not elapsed, the service providing server 130 transmits information about the product delivery cancelation to the second terminal 120 (Step 617). In this case, the service providing server 130 confirms whether agreement according to the product delivery cancelation is made from the second terminal 120, and may decide to cancel the product delivery.

The service providing server 130 performs a refund process of the product purchase cost to the first terminal 110 (Step 619).

The service providing server 130 transmits information about the product delivery cancelation success to the first terminal 110 (Step 621).

On the contrary, the second terminal 120 requests the service providing server 130 to cancel the product delivery (Step 623). In this case, the second terminal 120 receives information for canceling the product delivery negotiation with the first terminal 110 input from the user.

When the service providing server 130 receives the product delivery cancelation request from the first terminal 110, the service providing server 130 determines whether the product delivery cancelable period has elapsed (Step 625). When the product delivery cancelable period has elapsed, the service providing server 130 proceeds to Step 627, and when the product delivery cancelable period has not elapsed, it proceeds to Step 629.

The service providing server 130 transmits the product delivery cancelation failure to the second terminal 120 with the lapse of the product delivery cancelable period (Step 627). Accordingly, the first terminal 110 and the second terminal 120 maintain the product delivery agreement.

However, when the product delivery cancelable period has not elapsed, the service providing server 130 transmits information about the product delivery cancelation to the first terminal 110 (Step 629). In this case, the service providing server 130 confirms whether agreement according to the product delivery cancelation is made from the first terminal 110, and may decide to cancel the product delivery.

The service providing server 130 performs a refund process of the product purchase cost to the first terminal 110 (Step 631). In addition, the service providing server 130 may transmit information whether the refund of the product purchase cost is made to the first terminal 110.

The service providing server 130 transmits information about the product delivery cancelation success to the second terminal 120 (Step 633).

The service providing server 130 may refund the product delivery fee according to the product delivery cancelation to the first terminal 110. If a cancelation fee according to the product delivery cancelation is set in the service providing server 130, the service providing server 130 may receive (charge) a predetermined cancelation fee from the terminal which transmitted the product delivery cancelation request.

FIG. 7 is an exemplary diagram illustrating an operation based on the product delivery failure according to the information. Referring to FIG. 7, a detailed operation of Step 431 according to the product delivery failure illustrated in FIG. 4b will be exemplarily described below. Hereinafter, reference numeral 431a denotes a product delivery failure operation of transmitting the product delivery failure from the first terminal 110 to the service providing server 130 since the second terminal 120 does not deliver the product. In addition, reference numeral 431b denotes a product delivery failure operation of transmitting the product delivery failure from the second terminal 120 to the service providing server 130 since the first terminal 110 does not receive (or pick up) the product.

When the product based on the agreement is not received from the user of the second terminal 120 at the time of product delivery, the first terminal 110 transmits the product delivery failure of the second terminal 120 to the service providing server 130 (Step 711).

The service providing server 130 transmits the product delivery failure notice to the second terminal 120 (Step 713).

Accordingly, the second terminal 120 confirms whether the product delivery fails (Step 715). Accordingly, when the product delivery has failed due to a fault of the second terminal 120, the process proceeds to Step 717, and when the product delivery failure is not caused by the fault of the second terminal 120, the process proceeds to Step 721.

When the second terminal 120 receives information agreeing to the product delivery failure input from the user, the second terminal 120 transmits product delivery failure confirmation to the service providing server 130 (Step 717).

The service providing server 130 refunds all of the product purchase and product delivery fees (Step 719). The service providing server 130 refunds in full the product purchase cost to the first terminal 110. In this case, when a failure fee (for example, about 5% of a product delivery fee) according to the product delivery failure is set in the service providing server 130, the service providing server 130 may refund in full the remaining product delivery fee except for the failure fee to the first terminal 110.

When the second terminal 120 receives information disagreeing to the product delivery failure input from the user, the second terminal 120 transmits the product delivery failure disagreement to the service providing server 130 (Step 721).

In this case, the service providing server 130 refunds a part of the product purchase and product delivery fees (Step 723). For example, the service providing server 130 refunds in full the product purchase cost to the first terminal 110. In this case, the service providing server 130 may provide a predetermined product delivery fee (for example, about 50% of a product delivery fee) according to the product failure to the second terminal 120, if the product delivery failure was not caused by the fault of the second terminal 120. The service providing server 130 can receive a failure fee from the predetermined product delivery fee paid to the second terminal 120 according to the product delivery.

The service providing server 130 transmits a delivery failure and delivery fee refund details to the first terminal 110 (Step 725).

On the contrary, when the product according to the agreement is not delivered to the user of the first terminal 110 at the time of product delivery, the second terminal 120 transmits a product reception failure of the first terminal 110 to the service providing server 130 (Step 727).

The service providing server 130 transmits a product reception failure notice to the first terminal 110 (Step 729).

Accordingly, the first terminal 110 confirms whether it is a product reception failure (Step 731). Accordingly, when the product reception has failed due to the fault of the first terminal 110, the process proceeds to Step 735, and when the product reception failure is not caused by the fault of the first terminal 110, the process proceeds to Step 737.

When the first terminal 110 receives information agreeing to the product reception failure input from the user, the first terminal 110 transmits a product reception failure confirmation to the service providing server 130 (Step 733).

In this case, the service providing server 130 refunds a part of the product purchase and product delivery fees (Step 735). For example, the service providing server 130 refunds in full the product purchase cost to the first terminal 110. In this case, the service providing server 130 may provide a predetermined product delivery fee (for example, about 50% of a product delivery fee) according to the product failure to the second terminal 120, if the product delivery failure was not caused by the fault of the second terminal 120. The service providing server 130 can receive a failure fee from the predetermined product delivery fee paid to the second terminal 120 according to the product delivery.

When the first terminal 110 receives information disagreeing to the product reception failure input from the user, the first terminal 110 transmits a product reception failure disagreement to the service providing server 130 (Step 737).

In this case, the service providing server 130 refunds in full the product purchase and product delivery fees to the first terminal 110 (Step 739). The service providing server 130 refunds in full the product purchase cost to the first terminal 110. In this case, when a failure fee (for example, about 5% of a product delivery fee) according to the product delivery failure is set in the service providing server 130, the service providing server 130 may receive the failure fee from the second terminal 120.

The service providing server 130 transmits the delivery failure to the second terminal 120 (Step 741).

The operations between the devices according to the product delivery service have been exemplarily described above with reference to FIG. 2 to FIG. 7, but are not limited to the operation sequence described above, and the operation sequences may be modified, eliminated, and added.

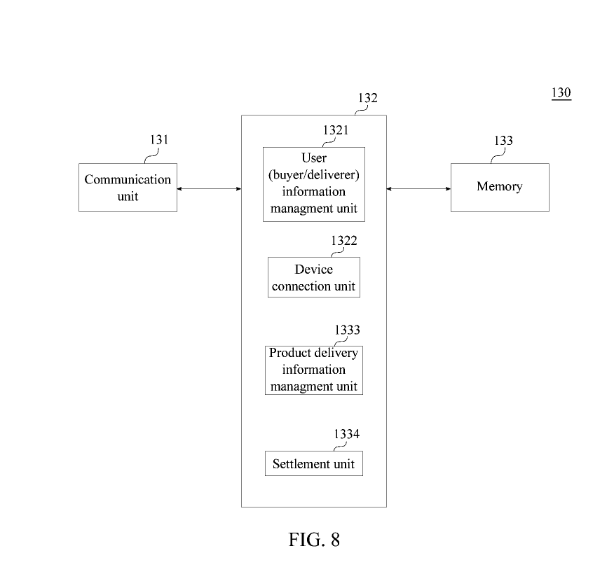

FIG. 8 is an exemplary diagram illustrating the service providing server according to the present invention. Referring to FIG. 8, the service providing server 130 includes a communication unit 131, a control unit 132, and a memory 133.

The communication unit 131 may be connected to terminals (for example, the first terminal 110 and the second terminal 120) and the financial sever 140 by wires or wireless. Accordingly, the communication unit 131 can receive product purchase information from the first terminal 110, and can receive product delivery information from the second terminal 120. The communication unit 131 can provide product delivery negotiation information between the terminals based on product delivery negotiation completion to the terminals. In addition, the communication unit 131 can manage the user information received from the terminals 110 and 120.

The communication unit 131 connects to the financial server 140 to receive financial service related to cost charging, payment, settlement, and the like, and transmits and receives information related to costs.

Meanwhile, the communication unit 131 may transmit and receive necessary information in addition to the information described above to and from the terminals 110 and 120 and the financial server 140.

The control unit 132 controls an overall operation of the service providing server 130. The control unit 132 includes a user information management unit 1331, a device connection unit 1332, a product delivery information management unit 1333, and a settlement unit 1334. The control unit 132 may be a central processing unit (CPU), a processor, or the like.

The user information management unit 1331 manages the user information input from the terminals 110 and 120. The user information includes at least one of name, address, e-mail address, nationality, phone number, ID, and password. The user information management unit 1331 manages information about the users of the terminals 110 and 120, that is, a buyer who requests delivery of a product or a deliverer who delivers the product to the buyer.

In addition, the user information management unit 1331 manages product purchase information received from the buyer terminals (the first terminal 110) and product delivery information received from the deliverer terminals (the second terminal 120). In addition, the user information management unit 1331 may provide the product delivery information to the buyer terminals or may provide the product purchase information to the deliverer terminals. For this purpose, the user information management unit 1331 can manage the product purchase information and the product delivery information in the form of a list.

The device connection unit 1332 connects the terminals 110 and 120 to each other for the product delivery negotiation, and enables the terminals to transmit texts, images, videos, and the like between them, for example, in the form of a chat box. The device connection unit 1332 can collect information necessary for product delivery during the product delivery negotiation, and can store the collected information in the memory. In addition, the device connection unit 1332 can receive product delivery approval information from the terminals 110 and 120 according to the product purchase agreement received from the terminals 110 and 120. In this case, when the device connection unit 1332 receives the product delivery approval information from both of the terminals 110 and 120 during the agreement, the device connection unit 1332 can confirm that the product delivery agreement is completed.

The product delivery information management unit 1333 receives the completion information of the product delivery negotiation between the buyer terminal and the deliverer terminal through the connection between the devices through the device connection unit 1332. The product delivery information management unit 1333 can manage the product delivery negotiation information between the terminals between which the product delivery approval is completed. Accordingly, the product delivery information management unit 1333 manages the product delivery negotiation information between the buyer terminal and the deliverer terminal between which the product delivery negotiation is completed, between the first terminal 110 and the second terminal 120. The product delivery information management unit 1333 manages information related to product price adjustment request, product delivery failure, and product delivery success after the product delivery negotiation is completed, and may provide the managed information to the terminals 110 and 120 between which the product delivery negotiation is completed.

The settlement unit 1334 manages the costs delivered between the terminals between which the product delivery negotiation is completed. The settlement unit 1334 may provide a settlement service based on a separate virtual money managed autonomously by the service providing server 130, or may operate in cooperation with the other settlement systems (for example, PayPal server or the like). The settlement unit 1334 enables the first terminal 110, which is the buyer terminal, to pay the costs to the second terminal 120, which is the deliverer terminal, and may operate in cooperation with the financial server 140. The settlement unit 1334 may charge the costs based on the product delivery success, the product delivery cancelation, the product delivery failure, and the like related to the product delivery, from the first terminal 110 or the second terminal 120. Meanwhile, the settlement unit 1334 may be embodied in the financial server 140.

The memory 133 stores and outputs the information input by the communication unit 131 or the control unit 132 (the user information management unit 1331, the device connection unit 1332, the product delivery information management unit 1333, and the settlement unit 1334).

Accordingly, the service providing server according to the present invention enables the deliverer terminal moving between areas or countries through various travel means, such as automobile, bus, train, ship, and airplane, and the buyer terminal that wants to buy products in those areas or countries to be connected to each other. The service providing server can provide the product delivery service which enables the buyer terminal and the deliverer terminal to request the purchase and delivery of the products. Accordingly, the buyer terminal can buy the desired product at the optimal price without spatial constraints through the service providing server.

The service providing server according to the present invention allows a buyer terminal to buy the product it wants at an optimal price without spatial constraints as the deliverer terminal travels between areas or countries, by mutual agreement of product delivery between individuals through connection between the buyer terminal and the deliverer terminal. In addition, since it is possible to receive the product directly through the user of the agreed deliverer terminal, it is possible to reduce the transport cost for product delivery.

Meanwhile, the specific embodiments have been described in the detailed description of the present invention, but it is obvious that the embodiments may be variously modified within the limit which does not deviate from the scope of the present invention. Therefore, the scope of the present invention should not limited to the embodiments described above, and should be defined by Claims to be described below and equivalents to Claims of the present invention.

Although the present invention has been explained in relation to its preferred embodiment, it is to be understood that many other possible modifications and variations can be made without departing from the spirit and scope of the present invention as hereinafter claimed.

What is claimed is:

1. A service providing server comprising:
a communication unit that communicates with a plurality of terminals;
a user information management unit that manages product purchase information and product delivery information received from the plurality of terminals, provides the product purchase information received from a buyer terminal among the plurality of terminals, to a deliverer terminal, and provides the product delivery information received from the deliverer terminal to the buyer terminal;
a device connection unit that, when a terminal corresponding to product delivery is selected by one of the buyer terminal or the deliverer terminal, connects the terminals to each other for product delivery negotiation with the selected terminal, and receives confirmation whether the product delivery negotiation between the buyer terminal and the deliverer terminal is completed;
a product delivery information management unit that manages product delivery negotiation information between the buyer terminal and the deliverer terminal between which the product delivery negotiation is completed, to be shared between the buyer terminal and the deliverer terminal; and
a memory that stores the product purchase information, the product delivery information, and the product delivery negotiation information.

2. The service providing server according to claim 1, wherein the user information management unit receives user information including at least one of name, address, e-mail address, nationality, phone number, ID, and password, input from the plurality of terminals.

3. The service providing server according to claim 1, wherein the product purchase information includes at least one of product destination, name of product purchased, number of products, product purchase price, product purchase link, image related to product purchased, detailed product information, and product delivery fee, and the product delivery information includes at least one of connection information between deliverer terminal and buyer terminal, destination, and travel schedule.

4. The service providing server according to claim 1, wherein the product delivery negotiation information includes information about the deliverer terminal and the buyer terminal between which the negotiation is completed, destination of the deliverer terminal, and travel schedule.

5. The service providing server according to claim 1, wherein the device connection unit connects the buyer terminal and the deliverer terminal to each other when the deliverer terminal is selected by the buyer terminal or the buyer terminal is selected by the deliverer terminal.

6. The service providing server according to claim 5, wherein the device connection unit activates a chat box capable of transmitting texts, images, and videos for connection between the buyer terminal and the deliverer terminal.

7. The service providing server according to claim 5, wherein the device connection unit confirms that the product delivery negotiation is completed when the device connection unit receives information agreeing to product delivery from both of the buyer terminal and the deliverer terminal.

8. A method for providing a product delivery service, the method comprises the steps of:
receiving user information input from a plurality of terminals;
receiving product purchase information for product purchase input from a buyer terminal, which wants to buy a product, among the plurality of terminals;
receiving product delivery information for product delivery input from the deliverer terminal, which wants to deliver a product, among the plurality of terminals;
providing the product purchase information to the deliverer terminal, and providing the product delivery information to the buyer terminal;
selecting a terminal for product purchase or product delivery from one of the buyer terminal or the deliverer terminal;
sharing information related to the product delivery negotiation with the buyer terminal and the deliverer terminal when product delivery negotiation with the selected terminal is completed; and
paying the cost to the deliverer terminal for the product delivery of the buyer terminal upon the approval of the buyer terminal through the product delivery negotiation.

9. The method for providing a product delivery service according to claim 8, further comprising receiving settlement related information for the product purchase and the product delivery input from the plurality of terminals.

10. The method for providing a product delivery service according to claim 8, wherein the user information includes at least one of name, address, e-mail address, nationality, phone number, ID, and password.

11. The method for providing a product delivery service according to claim 8, wherein the product purchase information includes at least one of product destination, name of product purchased, number of products, product purchase price, product purchase link, image related to product purchased, detailed product information, and product delivery fee, and the product delivery information includes at least one of connection information between deliverer terminal and buyer terminal, destination, and travel schedule.

12. The method for providing a product delivery service according to claim 8, wherein the product delivery negotiation information includes information about the deliverer terminal and the buyer terminal between which the negotiation is completed, destination of the deliverer terminal, and travel schedule.

13. The method for providing a product delivery service according to claim 8, further comprising connecting the buyer terminal and the deliverer terminal to each other after the selection of the terminal for product purchase or product delivery.

14. The method for providing a product delivery service according to claim 13, wherein the connecting includes activating a chat box capable of transmitting texts, images, and videos between the buyer terminal and the deliverer terminal.

15. The method for providing a product delivery service according to claim 8, wherein the sharing of the information with the buyer terminal and the deliverer terminal includes confirming that the product delivery negotiation is completed when receiving information agreeing to product delivery from both of the buyer terminal and the deliverer terminal.

16. The method for providing a product delivery service, the method according to claim 8 further comprises steps proceeding the sharing of the information related to the product delivery negotiation with the buyer terminal and the deliverer terminal, wherein the steps are:
receiving a product price adjustment request from one of the buyer terminal or the deliverer terminal; and
resetting the product price when receiving information agreeing to the product price adjusted through the deliverer terminal or the buyer terminal corresponding to the receiving of the product price request, and completing the product delivery negotiation when receiving information disagreeing to the adjusted product price.

17. The method for providing a product delivery service, the method according to claim 8 further comprises steps proceeding the sharing of the information related to the product delivery negotiation with the buyer terminal and the deliverer terminal, wherein the steps are:
receiving a product price cancelation request from one of the buyer terminal or the deliverer terminal; and
canceling the product delivery when a predetermined product delivery cancelable period is not elapsed through determination whether the predetermined product delivery cancelable period is elapsed according to the product delivery cancelation request, and reporting a product delivery cancel failure when the product delivery cancelable period is elapsed.

18. The method for providing a product delivery service, the method according to claim 8 further comprises steps proceeding the sharing of the information related to the product delivery negotiation with the buyer terminal and the deliverer terminal, wherein the steps are:
receiving a product delivery failure request from one of the buyer terminal or the deliverer terminal; and
refunding, to the buyer terminal, a part or all of product delivery fees and all product purchase prices to the buyer terminal, according to the receiving of information agreeing to the product delivery failure through the deliverer terminal or the buyer terminal corresponding to the product delivery failure.
